(19) United States
(12) Patent Application Publication
(10) Pub. No.: US 2021/0397380 A1
(43) Pub. Date: Dec. 23, 2021

(54) DYNAMIC PAGE ACTIVATION

(71) Applicant: Micron Technology, Inc., Boise, ID (US)

(72) Inventors: Taeksang Song, San Jose, CA (US); Chinnakrishnan Ballapuram, San Jose, CA (US); Saira S. Malik, Lafayette, IN (US)

(21) Appl. No.: 17/349,616

(22) Filed: Jun. 16, 2021

Related U.S. Application Data
(60) Provisional application No. 63/042,948, filed on Jun. 23, 2020.

(51) Int. Cl. G06F 3/06

(52) U.S. Cl. CPC G06F 3/0659; G06F 3/0679; G06F 3/0604; G06F 3/0644

(57) ABSTRACT

Methods, systems, and devices for dynamic page activation are described. In some examples, one or more components of a memory device (e.g., an interface controller of a memory device) may receive a first read command for a first page of data stored at a memory array. The memory device may determine, based on one or more prior access operations, that a second read command for a second page of data may be received. The memory device may prefetch (e.g., read) the second page of data such that when the second read command is received, the data may have already been read and may be communicated (e.g., to a host device) in response to the second read command.

### CROSS REFERENCE

The present application for patent claims the benefit of U.S. Provisional Patent Application No. 63/042,948 by SONG et al., entitled “DYNAMIC PAGE ACTIVATION,” filed Jul. 23, 2020, assigned to the assignee hereof, and expressly incorporated by reference herein.

### BACKGROUND

The following relates generally to memory systems and memory subsystems and more specifically to dynamic page activation.

Memory devices are widely used to store information in various electronic devices such as computers, wireless communication devices, cameras, digital displays, and the like. Information is stored by programing memory cells within a memory device to various states. For example, binary memory cells may be programmed to one of two supported states, often denoted by a logic 1 or a logic 0. In some examples, a single memory cell may support more than two states, any one of which may be stored. To access the stored information, a component may read, or sense, at least one stored state in the memory device. To store information, a component may write, or program, the state in the memory device.

Various types of memory devices and memory cells exist, including magnetic hard disks, random access memory (RAM), read-only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), flash memory, phase change memory (PCM), self-selecting memory, chalcogenide memory technologies, and others. Memory cells may be volatile or non-volatile. Non-volatile memory, e.g., FeRAM, may maintain their stored logic state for extended periods of time even in the absence of an external power source. Volatile memory devices, e.g., DRAM, may lose their stored state when disconnected from an external power source.

### BRIEF DESCRIPTION OF THE DRAWINGS

FIG. 1 illustrates an example of a system that supports dynamic page activation in accordance with examples as disclosed herein.

FIG. 2 illustrates an example of a memory die that supports dynamic page activation in accordance with examples as disclosed herein.

FIG. 3 illustrates an example of a memory subsystem that supports dynamic page activation in accordance with examples as disclosed herein.

FIG. 4 illustrates an example of a flow diagram that illustrates dynamic page activation in accordance with examples as disclosed herein.

FIG. 5 shows a block diagram of an interface controller that supports dynamic page activation in accordance with aspects of the present disclosure.

FIGS. 6 through 9 show flowcharts illustrating a method or methods that support dynamic page activation in accordance with examples as disclosed herein.

### DETAILED DESCRIPTION

A memory system may include one or more memory devices as a main memory (e.g., a primary memory for storing information among other operations) for a host device (e.g., a system on chip (SoC) or processor). For example, a memory system may include a non-volatile memory (e.g., FeRAM) that stores data for the memory system. Compared to volatile memory, the non-volatile memory may provide benefits such as non-volatility, higher capacity, and lower power consumption. However, accessing pages of the non-volatile memory in multiple, consecutive read operations may increase the overall power consumption of the memory system and may increase system latency.

According to the techniques described herein, the power consumption and latency of a memory device may be decreased by prefetching one or more pages of data from the non-volatile memory. The memory system may include a memory controller (e.g., an interface controller) configured to receive a read command for a first page of data. The memory controller may include logic that tracks access history of each page of data of the non-volatile memory array. The logic may be configured to determine that, for example, when a first page of data is accessed a second page of data is often accessed thereafter. The memory controller may then access (e.g., read) the first page of data and prefetch the second page of data in a same operation (e.g., a same access operation). The first page of data may be transmitted to the host device and the second page of data may be stored (e.g., temporarily stored) to a bank of volatile memory cells (e.g., a buffer) until a read command for the second page is received. When the read command for the second page is received, the second page of data may be read directly from the bank of volatile memory cells, which may reduce the overall power consumption and latency of the memory array that would otherwise be incurred due to performing an additional read operation for the second page of data.

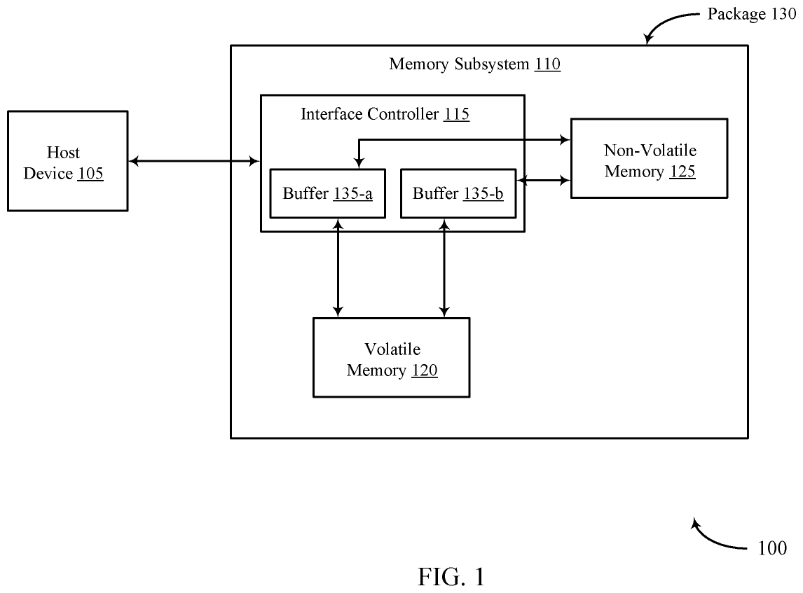

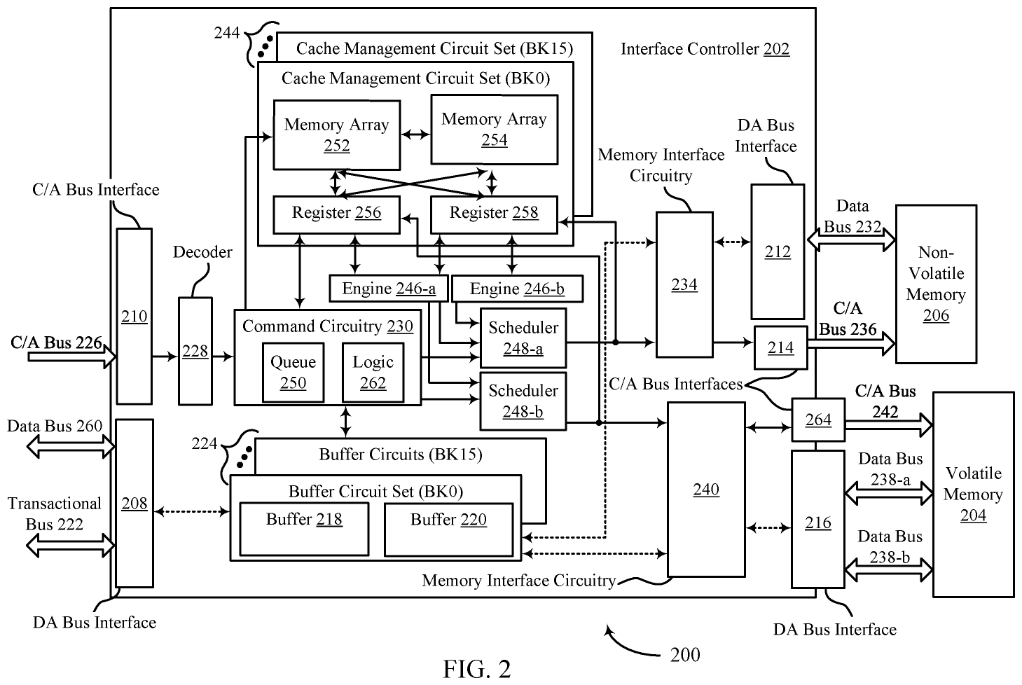

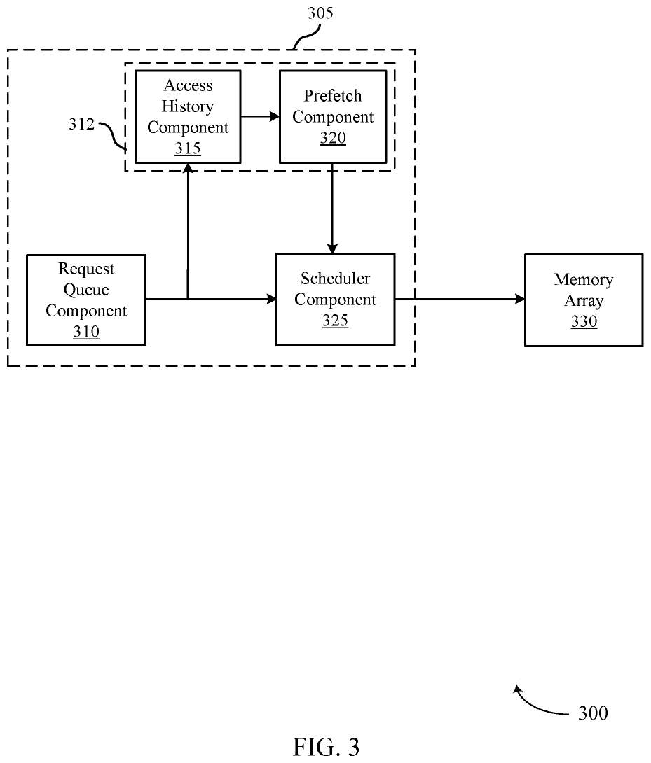

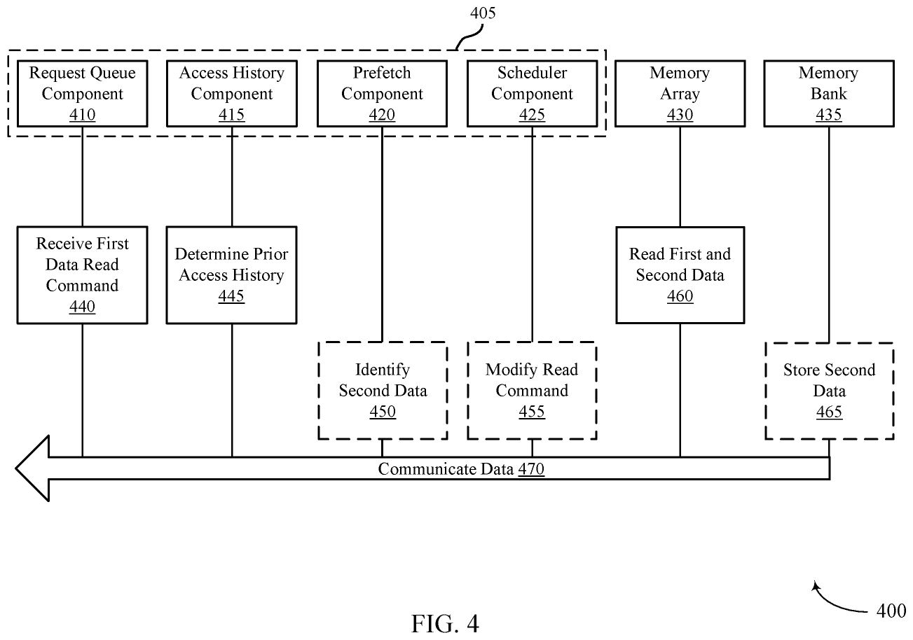

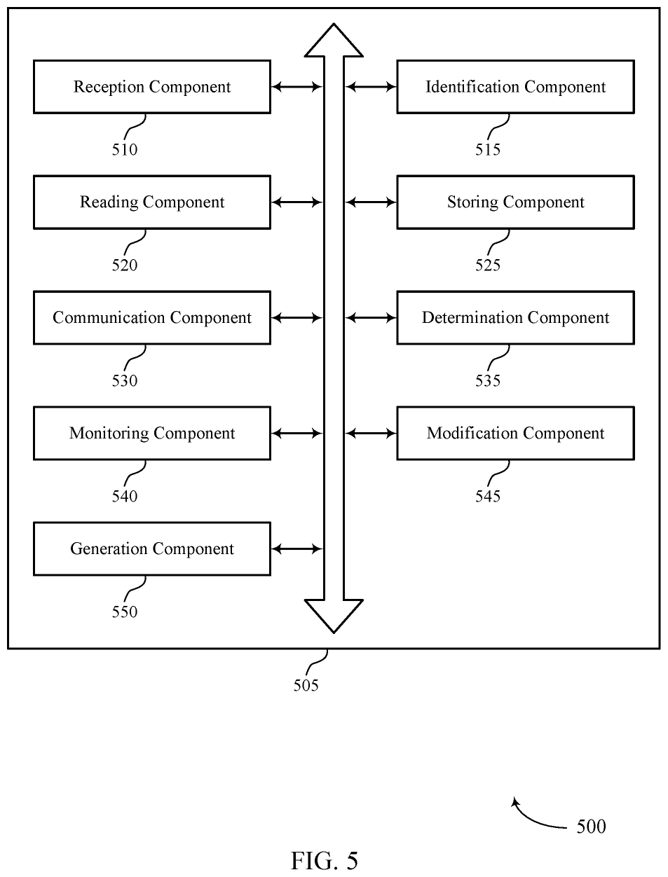

Features of the disclosure are initially described in the context of memory systems and dies as described with reference to FIGS. 1 and 2. Features of the disclosure are described in the context of a memory subsystem and process flow diagram as described with reference to FIGS. 3 and 4. These and other features of the disclosure are further illustrated by and described with reference to an apparatus diagram and flowcharts that relate to dynamic page activation as described with reference to FIGS. 5-9.

FIG. 1 illustrates an example of a memory system 100 that supports dynamic page activation in accordance with examples as disclosed herein. The memory system 100 may be included in an electronic device such a computer or phone. The memory system 100 may include a host device 105 and a memory subsystem 110. The host device 105 may be a processor or system-on-a-chip (SoC) that interfaces with the interface controller 115 as well as other components of the electronic device that includes the memory system 100. The memory subsystem 110 may store and provide access to electronic information (e.g., digital information, data) for the host device 105. The memory subsystem 110 may include an interface controller 115, a volatile memory 120, and a non-volatile memory 125. In some examples, the interface controller 115, the volatile memory 120, and the non-volatile memory 125 may be included in a same physical package such as a package 130. However, the interface controller 115, the volatile memory 120, and the non-volatile memory 125 may be disposed on different, respective dies (e.g., silicon dies).

The devices in the memory system 100 may be coupled by various conductive lines (e.g., traces, printed circuit board (PCB) routing, redistribution layer (RDL) routing) that may enable the communication of information (e.g., commands, addresses, data) between the devices. The conductive lines may make up channels, data buses, command buses, address buses, and the like.

The memory subsystem 110 may be configured to provide the benefits of the non-volatile memory 125 while maintaining compatibility with a host device 105 that supports protocols for a different type of memory, such as the volatile memory 120, among other examples. For example, the non-volatile memory 125 may provide benefits (e.g., relative to the volatile memory 120) such as non-volatility, higher capacity, or lower power consumption. But the host device 105 may be incompatible or inefficiently configured with various aspects of the non-volatile memory 125. For instance, the host device 105 may support voltages, access latencies, protocols, page sizes, etc. that are incompatible with the non-volatile memory 125. To compensate for the incompatibility between the host device 105 and the non-volatile memory 125, the memory subsystem 110 may be configured with the volatile memory 120, which may be compatible with the host device 105 and serve as a cache for the non-volatile memory 125. Thus, the host device 105 may use protocols supported by the volatile memory 120 while benefitting from the advantages of the non-volatile memory 125.

In some examples, the memory system 100 may be included in, or coupled with, a computing device, electronic device, mobile computing device, or wireless device. The device may be a portable electronic device. For example, the device may be a computer, a laptop computer, a tablet computer, a smartphone, a cellular phone, a wearable device, an internet-connected device, or the like. In some examples, the device may be configured for bi-directional wireless communication via a base station or access point. In some examples, the device associated with the memory system 100 may be capable of machine-type communication (MTC), machine-to-machine (M2M) communication, or device-to-device (D2D) communication. In some examples, the device associated with the memory system 100 may be referred to as a user equipment (UE), station (STA), mobile terminal, or the like.

The host device 105 may be configured to interface with the memory subsystem 110 using a first protocol (e.g., low-power double data rate (LPDDR)) supported by the interface controller 115. Thus, the host device 105 may, in some examples, interface with the interface controller 115 directly and the non-volatile memory 125 and the volatile memory 120 indirectly. In alternative examples, the host device 105 may interface directly with the non-volatile memory 125 and the volatile memory 120. The host device 105 may also interface with other components of the electronic device that includes the memory system 100. The host device 105 may be or include an SoC, a general-purpose processor, a digital signal processor (DSP), an application-specific integrated circuit (ASIC), a field-programmable gate array (FPGA) or other programmable logic device, discrete gate or transistor logic, discrete hardware components, or it may be a combination of these types of components. In some examples, the host device 105 may be referred to as a host.

The interface controller 115 may be configured to interface with the volatile memory 120 and the non-volatile memory 125 on behalf of the host device 105 (e.g., based on one or more commands or requests issued by the host device 105). For instance, the interface controller 115 may facilitate the retrieval and storage of data in the volatile memory 120 and the non-volatile memory 125 on behalf of the host device 105. Thus, the interface controller 115 may facilitate data transfer between various subcomponents, such as between at least some of the host device 105, the volatile memory 120, or the non-volatile memory 125. The interface controller 115 may interface with the host device 105 and the volatile memory 120 using the first protocol and may interface with the non-volatile memory 125 using a second protocol supported by the non-volatile memory 125.

The non-volatile memory 125 may be configured to store digital information (e.g., data) for the electronic device that includes the memory system 100. Accordingly, the non-volatile memory 125 may include an array or arrays of memory cells and a local memory controller configured to operate the array(s) of memory cells. In some examples, the memory cells may be or include FeRAM cells (e.g., the non-volatile memory 125 may be FeRAM).

The non-volatile memory 125 may be configured to interface with the interface controller 115 using the second protocol that is different than the first protocol used between the interface controller 115 and the host device 105. In some examples, the non-volatile memory 125 may have a longer latency for access operations than the volatile memory 120. For example, retrieving data from the non-volatile memory 125 may take longer than retrieving data from the volatile memory 120. Similarly, writing data to the non-volatile memory 125 may take longer than writing data to the volatile memory 120. In some examples, the non-volatile memory 125 may have a smaller page size than the volatile memory 120, as described herein.

The volatile memory 120 may be configured to operate as a cache for one or more components, such as the non-volatile memory 125. For example, the volatile memory 120 may store information (e.g., data) for the electronic device that includes the memory system 100. Accordingly, the volatile memory 120 may include an array or arrays of memory cells and a local memory controller configured to operate the array(s) of memory cells. In some examples, the memory cells may be or include DRAM cells (e.g., the volatile memory may be DRAM). The non-volatile memory 125 may be configured to interface with the interface controller 115 using the first protocol that is used between the interface controller 115 and the host device 105.

In some examples, the volatile memory 120 may have a shorter latency for access operations than the non-volatile memory 125. For example, retrieving data from the volatile memory 120 may take less time than retrieving data from the non-volatile memory 125. Similarly, writing data to the volatile memory 120 may take less time than writing data to the non-volatile memory 125. In some examples, the volatile memory 120 may have a larger page size than the non-volatile memory 125. For instance, the page size of volatile memory 120 may be 2 kilobytes (2 kB) and the page size of non-volatile memory 125 may be 64 bytes (64B) or 128 bytes (128B).

Although the non-volatile memory 125 may be a higher-density memory than the volatile memory 120, accessing the non-volatile memory 125 may take longer than accessing the volatile memory 120 (e.g., due to different architectures and protocols, among other reasons). So operating the volatile memory 120 as a cache may reduce latency in the memory system 100. As an example, an access request for data from the host device 105 may be satisfied relatively quickly by retrieving the data from the volatile memory 120 rather than from the non-volatile memory 125. To facilitate operation of the volatile memory 120 as a cache, the interface controller 115 may include multiple buffers 135. The buffers 135 may be disposed on the same die as the interface controller 115 and may be configured to temporarily store data for transfer between the volatile memory 120, the non-volatile memory 125, or the host device 105 (or any combination thereof) during one or more access operations (e.g., storage and retrieval operations).

An access operation may also be referred to as an access process or access procedure and may involve one or more sub-operations that are performed by one or more of the components of the memory subsystem 110. Examples of access operations may include storage operations in which data provided by the host device 105 is stored (e.g., written to) in the volatile memory 120 or the non-volatile memory 125 (or both), and retrieval operations in which data requested by the host device 105 is obtained (e.g., read) from the volatile memory 120 or the non-volatile memory 125 and is returned to the host device 105.

To store data in the memory subsystem 110, the host device 105 may initiate a storage operation (or “storage process”) by transmitting a storage command (also referred to as a storage request, a write command, or a write request) to the interface controller 115. The storage command may target a set of non-volatile memory cells in the non-volatile memory 125. In some examples, a set of memory cells may also be referred to as a portion of memory. The host device 105 may also provide the data to be written to the set of non-volatile memory cells to the interface controller 115. The interface controller 115 may temporarily store the data in the buffer 135-a. After storing the data in the buffer 135-a, the interface controller 115 may transfer the data from the buffer 135-a to the volatile memory 120 or the non-volatile memory 125 or both. In write-through mode, the interface controller 115 may transfer the data to both the volatile memory 120 and the non-volatile memory 125. In write-back mode, the interface controller 115 may only transfer the data to the volatile memory 120.

In either mode, the interface controller 115 may identify an appropriate set of one or more volatile memory cells in the volatile memory 120 for storing the data associated with the storage command. To do so, the interface controller 115 may implement set-associative mapping in which each set (e.g., block) of one or more non-volatile memory cells in the non-volatile memory 125 may be mapped to multiple sets of volatile memory cells in the volatile memory 120. For instance, the interface controller 115 may implement n-way associative mapping which allows data from a set of non-volatile memory cells to be stored in one of n sets of volatile memory cells in the volatile memory 120. Thus, the interface controller 115 may manage the volatile memory 120 as a cache for the non-volatile memory 125 by referencing the n sets of volatile memory cells associated with a targeted set of non-volatile memory cells. As used herein, a “set” of objects may refer to one or more of the objects unless otherwise described or noted. Although described with reference to set-associative mapping, the interface controller 115 may manage the volatile memory 120 as a cache by implementing one or more other types of mapping such as direct mapping or associative mapping, among other examples.

After determining which n sets of volatile memory cells are associated with the targeted set of non-volatile memory cells, the interface controller 115 may store the data in one or more of the n sets of volatile memory cells. This way, a subsequent retrieval command from the host device 105 for the data can be efficiently satisfied by retrieving the data from the lower-latency volatile memory 120 instead of retrieving the data from the higher-latency non-volatile memory 125. The interface controller 115 may determine which of the n sets of the volatile memory 120 to store the data based on one or more parameters associated with the data stored in the n sets of the volatile memory 120, such as the validity, age, or modification status of the data. Thus, a storage command by the host device 105 may be wholly (e.g., in write-back mode) or partially (e.g., in write-through mode) satisfied by storing the data in the volatile memory 120. To track the data stored in the volatile memory 120, the interface controller 115 may store for one or more sets of volatile memory cells (e.g., for each set of volatile memory cells) a tag address that indicates the non-volatile memory cells with data stored in a given set of volatile memory cells.

To retrieve data from the memory subsystem 110, the host device 105 may initiate a retrieval operation (also referred to as a retrieval process) by transmitting a retrieval command (also referred to as a retrieval request, a read command, or a read request) to the interface controller 115. The retrieval command may target a set of one or more non-volatile memory cells in the non-volatile memory 125. Upon receiving the retrieval command, the interface controller 115 may check for the requested data in the volatile memory 120. For instance, the interface controller 115 may check for the requested data in the n sets of volatile memory cells associated with the targeted set of non-volatile memory cells. If one of the n sets of volatile memory cells stores the requested data (e.g., stores data for the targeted set of non-volatile memory cells), the interface controller 115 may transfer the data from the volatile memory 120 to the buffer 135-a so that it can be transmitted to the host device 105. The term “hit” may be used to refer to the scenario where the volatile memory 120 stores data requested by the host device 105. If then sets of one or more volatile memory cells do not store the requested data (e.g., the n sets of volatile memory cells store data for a set of non-volatile memory cells other than the targeted set of non-volatile memory cells), the interface controller 115 may transfer the requested data from the non-volatile memory 125 to the buffer 135-a so that it can be transmitted to the host device 105. The term “miss” may be used to refer to the scenario where the volatile memory 120 does not store data requested by the host device 105.

In a miss scenario, after transferring the requested data to the buffer 135-a, the interface controller 115 may transfer the requested data from the buffer 135-a to the volatile memory 120 so that subsequent read requests for the data can be satisfied by the volatile memory 120 instead of the non-volatile memory 125. For example, the interface controller 115 may store the data in one of the n sets of volatile memory cells associated with the targeted set of non-volatile memory cells. But the n sets of volatile memory cells may already be storing data for other sets of non-volatile memory cells. So, to preserve this other data, the interface controller 115 may transfer the other data to the buffer 135-b so that it can be transferred to the non-volatile memory 125 for storage. Such a process may be referred to as “eviction” and the data transferred from the volatile memory 120 to the buffer 135-b may be referred to as “victim” data. In some cases, the interface controller 115 may transfer a subset of the victim data from the buffer 135-b to the non-volatile memory 125. For example, the interface controller 115 may transfer one or more subsets of victim data that have changed since the data was initially stored in the non-volatile memory 125. Data that is inconsistent between the volatile memory 120 and the non-volatile memory 125 (e.g., due to an update in one memory and not the other) may be referred to in some cases as “modified” or “dirty” data. In some examples (e.g., when interface controller operates in one mode such as a write-back mode), dirty data may be data that is present in the volatile memory 120 but not present in the non-volatile memory 125.

The memory subsystem 110 may support dynamic page activation as described herein. In some examples, the interface controller 115 may receive read commands from the host device 105 for data (e.g., pages of data) stored at the non-volatile memory 125. For example, the interface controller 115 may receive a first read command for a first page of data stored at the non-volatile memory 125. The interface controller 115 may read the first page of data stored at the non-volatile memory 125, and the first page of data may be stored (e.g., temporarily stored) to a buffer 135 before being communicated to the host device 105.

In some examples, the interface controller 115 may include logic for prefetching one or more additional pages of data based on the first read command. The logic may, over time, track access operations performed on the non-volatile memory 125. The tracked access operations (e.g., the prior access history of the non-volatile memory 125) may indicate that one or more pages of data are often accessed together (e.g., accessed within a threshold duration of the other).

For example, when the interface controller 115 receives a first read command for a first page of data, the logic may determine that the memory subsystem 110 is likely to receive a read command for a second page of data. The interface controller 115 may then read the first page of data and read (e.g., prefetch) the second page of data. The first page of data may be communicated to the host device 105. In some examples, the second page of data may also be communicated to the host device 105, or the second page of data may be stored (e.g., temporarily stored) to the volatile memory 120 until the memory subsystem 110 receives a second read command (e.g., a read command for the second page of data). Prefetching the second page of data before an associated read command may reduce the overall power consumption and latency of the memory subsystem that would otherwise be incurred by performing separate read operations on the non-volatile memory 125 for both the first page and second page of data.

FIG. 2 illustrates an example of memory subsystem 200 that supports dynamic page activation in accordance with examples as disclosed herein. The memory subsystem 200 may be an example of the memory subsystem 110 described with reference to FIG. 1. Accordingly, the memory subsystem 200 may interact with a host device as described with reference to FIG. 1. The memory subsystem 200 may include an interface controller 202, a volatile memory 204, and a non-volatile memory 206, which may be examples of the interface controller 115, the volatile memory 120, and the non-volatile memory 125, respectively, as described with reference to FIG. 1. Thus, the interface controller 202 may interface with the volatile memory 204 and the non-volatile memory 206 on behalf of the host device as described with reference to FIG. 1. For example, the interface controller 202 may operate the volatile memory 204 as a cache for the non-volatile memory 206. Operating the volatile memory 204 as the cache may allow subsystem to provide the benefits of the non-volatile memory 206 (e.g., non-volatile, high-density storage) while maintaining compatibility with a host device that supports a different protocol than the non-volatile memory 206.

In FIG. 2, dashed lines between components represent the flow of data or communication paths for data and solid lines between components represent the flow of commands or communication paths for commands. In some cases, the memory subsystem 200 is one of multiple similar or identical subsystems that may be included in an electronic device. Each subsystem may be referred to as a slice and may be associated with a respective channel of a host device in some examples.

The non-volatile memory 206 may be configured to operate as a main memory (e.g., memory for long-term data storage) for a host device. In some cases, the non-volatile memory 206 may include one or more arrays of FeRAM cells. Each FeRAM cell may include a selection component and a ferroelectric capacitor, and may be accessed by applying appropriate voltages to one or more access lines such as word lines, plates lines, and digit lines. In some examples, a subset of FeRAM cells coupled with to an activated word line may be sensed, for example concurrently or simultaneously, without having to sense all FeRAM cells coupled with the activated word line. Accordingly, a page size for an FeRAM array may be different than (e.g., smaller than) a DRAM page size. In the context of a memory device, a page may refer to the memory cells in a row (e.g., a group of the memory cells that have a common row address) and a page size may refer to the number of memory cells or column addresses in a row, or the number of column addresses accessed during an access operation. Alternatively, a page size may refer to a size of data handled by various interfaces. In some cases, different memory device types may have different page sizes. For example, a DRAM page size (e.g., 2 kB) may be a superset of a non-volatile memory (e.g., FeRAM) page size (e.g., 64 B).

A smaller page size of an FeRAM array may provide various efficiency benefits, as an individual FeRAM cell may require more power to read or write than an individual DRAM cell. For example, a smaller page size for an FeRAM array may facilitate effective energy usage because a smaller number of FeRAM cells may be activated when an associated change in information is minor. In some examples, the page size for an array of FeRAM cells may vary, for example dynamically (e.g., during operation of the array of FeRAM cells) depending on the nature of data and command utilizing FeRAM operation.

Although an individual FeRAM cell may require more power to read or write than an individual DRAM cell, an FeRAM cell may maintain its stored logic state for an extended period of time in the absence of an external power source, as the ferroelectric material in the FeRAM cell may maintain a non-zero electric polarization in the absence of an electric field. Therefore, including an FeRAM array in the non-volatile memory 206 may provide efficiency benefits relative to volatile memory cells (e.g., DRAM cells in the volatile memory 204), as it may reduce or eliminate requirements to perform refresh operations.

The volatile memory 204 may be configured to operate as a cache for the non-volatile memory 206. In some cases, the volatile memory 204 may include one or more arrays of DRAM cells. Each DRAM cell may include a capacitor that includes a dielectric material to store a charge representative of the programmable state. The memory cells of the volatile memory 204 may be logically grouped or arranged into one or more memory banks (as referred to herein as “banks”). For example, volatile memory 204 may include sixteen banks. The memory cells of a bank may be arranged in a grid or an array of intersecting columns and rows and each memory cell may be accessed or refreshed by applying appropriate voltages to the digit line (e.g., column line) and word line (e.g., row line) for that memory cell. The rows of a bank may be referred to pages, and the page size may refer to the number of columns or memory cells in a row. As noted, the page size of the volatile memory 204 may be different than (e.g., larger than) the page size of the non-volatile memory 206.

The interface controller 202 may include various circuits for interfacing (e.g., communicating) with other devices, such as a host device, the volatile memory 204, and the non-volatile memory 206. For example, the interface controller 202 may include a data (DA) bus interface 208, a command and address (C/A) bus interface 210, a data bus interface 212, a C/A bus interface 214, a data bus interface 216, and a C/A bus interface 264. The data bus interfaces may support the communication of information using one or more communication protocols. For example, the data bus interface 208, the C/A bus interface 210, the data bus interface 216, and the C/A bus interface 264 may support information that is communicated using a first protocol (e.g., LPDDR signaling), whereas the data bus interface 212 and the C/A bus interface 214 may support information communicated using a second protocol. Thus, the various bus interfaces coupled with the interface controller 202 may support different amounts of data or data rates.

The data bus interface 208 may be coupled with the data bus 260, the transactional bus 222, and the buffer circuitry 224. The data bus interface 208 may be configured to transmit and receive data over the data bus 260 and control information (e.g., acknowledgements/negative acknowledgements) or metadata over the transactional bus 222. The data bus interface 208 may also be configured to transfer data between the data bus 260 and the buffer circuitry 224. The data bus 260 and the transactional bus 222 may be coupled with the interface controller 202 and the host device such that a conductive path is established between the interface controller 202 and the host device. In some examples, the pins of the transactional bus 222 may be referred to as data mask inversion (DMI) pins. Although shown with one data bus 260 and one transactional bus 222, there may be any number of data buses 260 and any number of transactional buses 222 coupled with one or more data bus interfaces 208.

The C/A bus interface 210 may be coupled with the C/A bus 226 and the decoder 228. The C/A bus interface 210 may be configured to transmit and receive commands and addresses over the C/A bus 226. The commands and addresses received over the C/A bus 226 may be associated with data received or transmitted over the data bus 260. The C/A bus interface 210 may also be configured to transmit commands and addresses to the decoder 228 so that the decoder 228 can decode the commands and relay the decoded commands and associated addresses to the command circuitry 230.

The data bus interface 212 may be coupled with the data bus 232 and the memory interface circuitry 234. The data bus interface 212 may be configured to transmit and receive data over the data bus 232, which may be coupled with the non-volatile memory 206. The data bus interface 212 may also be configured to transfer data between the data bus 232 and the memory interface circuitry 234. The C/A bus interface 214 may be coupled with the C/A bus 236 and the memory interface circuitry 234. The C/A bus interface 214 may be configured to receive commands and addresses from the memory interface circuitry 234 and relay the commands and the addresses to the non-volatile memory 206 (e.g., to a local controller of the non-volatile memory 206) over the C/A bus 236. The commands and the addresses transmitted over the C/A bus 236 may be associated with data received or transmitted over the data bus 232. The data bus 232 and the C/A bus 236 may be coupled with the interface controller 202 and the non-volatile memory 206 such that conductive paths are established between the interface controller 202 and the non-volatile memory 206.

The data bus interface 216 may be coupled with the data buses 238 and the memory interface circuitry 240. The data bus interface 216 may be configured to transmit and receive data over the data buses 238, which may be coupled with the volatile memory 204. The data bus interface 216 may also be configured to transfer data between the data buses 238 and the memory interface circuitry 240. The C/A bus interface 264 may be coupled with the C/A bus 242 and the memory interface circuitry 240. The C/A bus interface 264 may be configured to receive commands and addresses from the memory interface circuitry 240 and relay the commands and the addresses to the volatile memory 204 (e.g., to a local controller of the volatile memory 204) over the C/A bus 242. The commands and addresses transmitted over the C/A bus 242 may be associated with data received or transmitted over the data buses 238. The data bus 238 and the C/A bus 242 may be coupled with the interface controller 202 and the volatile memory 204 such that conductive paths are established between the interface controller 202 and the volatile memory 204.

In addition to buses and bus interfaces for communicating with coupled devices, the interface controller 202 may include circuitry for operating the non-volatile memory 206 as a main memory and the volatile memory 204 as a cache. For example, the interface controller 202 may include command circuitry 230, buffer circuitry 224, cache management circuitry 244, one or more engines 246, and one or more schedulers 248.

The command circuitry 230 may be coupled with the buffer circuitry 224, the decoder 228, the cache management circuitry 244, and the schedulers 248, among other components. The command circuitry 230 may be configured to receive command and address information from the decoder 228 and store the command and address information in the queue 250. The command circuitry 230 may include logic 262 that processes command information (e.g., from a host device) and storage information from other components (e.g., the cache management circuitry 244, the buffer circuitry 224) and uses that information to generate one or more commands for the schedulers 248. The command circuitry 230 may also be configured to transfer address information (e.g., address bits) to the cache management circuitry 244. In some examples, the logic 26 2522 may be a circuit configured to operate as a finite state machine (FSM).

The buffer circuitry 224 may be coupled with the data bus interface 208, the command circuitry 230, the memory interface circuitry 234, and the memory interface circuitry 234. The buffer circuitry 224 may include a set of one or more buffer circuits for at least some banks, if not each bank, of the volatile memory 204. The buffer circuitry 224 may also include components (e.g., a memory controller) for accessing the buffer circuits. In one example, the volatile memory 204 may include sixteen banks and the buffer circuitry 224 may include sixteen sets of buffer circuits. Each set of the buffer circuits may be configured to store data from or for (or both) a respective bank of the volatile memory 204. As an example, the buffer circuit set for bank 0 (BK0) may be configured to store data from or for (or both) the first bank of the volatile memory 204 and the buffer circuit for bank 15 (BK15) may be configured to store data from or for (or both) the sixteenth bank of the volatile memory 204.

Each set of buffer circuits in the buffer circuitry 224 may include a pair of buffers. The pair of buffers may include one buffer (e.g., an open page data (OPD) buffer) configured to store data targeted by an access command (e.g., a storage command or retrieval command) from the host device and another buffer (e.g., a victim page data (VPD) buffer) configured to store data for an eviction process that results from the access command. For example, the buffer circuit set for BK0 may include the buffer 218 and the buffer 220, which may be examples of buffer 135-a and 135-b, respectively. The buffer 218 may be configured to store BK0 data that is targeted by an access command from the host device. And the buffer 220 may be configured to store data that is transferred from BK0 as part of an eviction process triggered by the access command. Each buffer in a buffer circuit set may be configured with a size (e.g., storage capacity) that corresponds to a page size of the volatile memory 204. For example, if the page size of the volatile memory 204 is 2 kB, the size of each buffer may be 2 kB. Thus, the size of the buffer may be equivalent to the page size of the volatile memory 204 in some examples.

The cache management circuitry 244 may be coupled with the command circuitry 230, the engines 246, and the schedulers 248, among other components. The cache management circuitry 244 may include a cache management circuit set for one or more banks (e.g., each bank) of volatile memory. As an example, the cache management circuitry 244 may include sixteen cache management circuit sets for BK0 through BK15. Each cache management circuit set may include two memory arrays that may be configured to store storage information for the volatile memory 204. As an example, the cache management circuit set for BK0 may include a memory array 252 (e.g., a CDRAM Tag Array (CDT-TA)) and a memory array 254 (e.g., a CDRAM Valid (CDT-V) array), which may be configured to store storage information for BK0. The memory arrays may also be referred to as arrays or buffers in some examples. In some cases, the memory arrays may be or include volatile memory cells, such as SRAM cells.

Storage information may include content information, validity information, or dirty information (or any combination thereof) associated with the volatile memory 204. Content information (which may also be referred to as tag information or address information) may indicate which data is stored in a set of volatile memory cells. For example, the content information (e.g., a tag address) for a set of one or more volatile memory cells may indicate which set of one or more non-volatile memory cells currently has data stored in the set of one or more volatile memory cells. Validity information may indicate whether the data stored in a set of volatile memory cells is actual data (e.g., data having an intended order or form) or placeholder data (e.g., data being random or dummy, not having an intended or important order). And dirty information may indicate whether the data stored in a set of one or more volatile memory cells of the volatile memory 204 is different than corresponding data stored in a set of one or more non-volatile memory cells of the non-volatile memory 206. For example, dirty information may indicate whether data stored in a set of volatile memory cells has been updated relative to data stored in the non-volatile memory 206.

The memory array 252 may include memory cells that store storage information (e.g., content and validity information) for an associated bank (e.g., BK0) of the volatile memory 204. The storage information may be stored on a per-page basis (e.g., there may be respective storage information for each page of the associated non-volatile memory bank). The interface controller 202 may check for requested data in the volatile memory 204 by referencing the storage information in the memory array 252. For instance, the interface controller 202 may receive, from a host device, a retrieval command for data in a set of non-volatile memory cells in the non-volatile memory 206. The interface controller 202 may use a set of one or more address bits (e.g., a set of row address bits) targeted by the access request to reference the storage information in the memory array 252. For instance, using set-associative mapping, the interface controller 202 may reference the content information in the memory array 252 to determine which set of volatile memory cells, if any, stores the requested data.

In addition to storing content information for volatile memory cells, the memory array 252 may also store validity information that indicates whether the data in a set of volatile memory cells is actual data (also referred to as valid data) or random data (also referred to as invalid data). For example, the volatile memory cells in the volatile memory 204 may initially store random data and continue to do so until the volatile memory cells are written with data from a host device or the non-volatile memory 206. To track which data is valid, the memory array 252 may be configured to set a bit for each set of volatile memory cells when actual data is stored in that set of volatile memory cells. This bit may be referred to a validity bit or a validity flag. As with the content information, the validity information stored in the memory array 252 may be stored on a per-page basis. Thus, each validity bit may indicate the validity of data stored in an associated page in some examples.

The memory array 254 may be similar to the memory array 252 and may also include memory cells that store validity information for a bank (e.g., BK0) of the volatile memory 204 that is associated with the memory array 252. However, the validity information stored in the memory array 254 may be stored on a sub-block basis as opposed to a per-page basis for the memory array 252. For example, the validity information stored in the memory cells of the memory array 254 may indicate the validity of data for subsets of volatile memory cells in a set (e.g., page) of volatile memory cells. As an example, the validity information in the memory array 254 may indicate the validity of each subset (e.g., 64B) of data in a page of data stored in BK0 of the volatile memory 204. Storing content information and validity information on a per-page basis in the memory array 252 may allow the interface controller 202 to quickly and efficiently determine whether there is a hit or miss for data in the volatile memory 204. Storing validity information on a sub-block basis may allow the interface controller 202 to determine which subsets of data to preserve in the non-volatile memory 206 during an eviction process.

Each cache management circuit set may also include a respective pair of registers coupled with the command circuitry 230, the engines 246, the memory interface circuitry 234, the memory interface circuitry 240, and the memory arrays for that cache management circuit set, among other components. For example, a cache management circuit set may include a first register (e.g., a register 256 which may be an open page tag (OPT) register) configured to receive storage information (e.g., one or more bits of tag information, validity information, or dirty information) from the memory array 252 or the scheduler 248-b or both. The cache management circuitry set may also include a second register (e.g., a register 258 which may be a victim page tag (VPT) register) configured to receive storage information from the memory array 254 and the scheduler 248-a or both. The information in the register 256 and the register 258 may be transferred to the command circuitry 230 and the engines 246 to enable decision-making by these components. For example, the command circuitry 230 may issue commands for reading the non-volatile memory 206 or the volatile memory 204 based on content information from the register 256.

The engine 246-a may be coupled with the register 256, the register 258, and the schedulers 248. The engine 246-a may be configured to receive storage information from various components and issue commands to the schedulers 248 based on the storage information. For example, when the interface controller 202 is in a first mode such as a write-through mode, the engine 246-a may issue commands to the scheduler 248-b and in response the scheduler 248-b to initiate or facilitate the transfer of data from the buffer 218 to both the volatile memory 204 and the non-volatile memory 206. Alternatively, when the interface controller 202 is in a second mode such as a write-back mode, the engine 246-a may issue commands to the scheduler 248-b and in response the scheduler 248-b may initiate or facilitate the transfer of data from the buffer 218 to the volatile memory 204. In the event of a write-back operation, the data stored in the volatile memory 204 may eventually be transferred to the non-volatile memory 206 during a subsequent eviction process.

The engine 246-b may be coupled with the register 258 and the scheduler 248-a. The engine 246-b may be configured to receive storage information from the register 258 and issue commands to the scheduler 248-a based on the storage information. For instance, the engine 246-b may issue commands to the scheduler 248-a to initiate or facilitate transfer of dirty data from the buffer 220 to the non-volatile memory 206 (e.g., as part of an eviction process). If the buffer 220 holds a set of data transferred from the volatile memory 204 (e.g., victim data), the engine 246-b may indicate which one or more subsets (e.g., which 64B) of the set of data in the buffer 220 should be transferred to the non-volatile memory 206.

The scheduler 248-a may be coupled with various components of the interface controller 202 and may facilitate accessing the non-volatile memory 206 by issuing commands to the memory interface circuitry 234. The commands issued by the scheduler 248-a may be based on commands from the command circuitry 230, the engine 246-a, the engine 246-b, or a combination of these components. Similarly, the scheduler 248-b may be coupled with various components of the interface controller 202 and may facilitate accessing the volatile memory 204 by issuing commands to the memory interface circuitry 240. The commands issued by the scheduler 248-b may be based on commands from the command circuitry 230 or the engine 246-a, or both.

The memory interface circuitry 234 may communicate with the non-volatile memory 206 via one or more of the data bus interface 212 and the C/A bus interface 214. For example, the memory interface circuitry 234 may prompt the C/A bus interface 214 to relay commands issued by the memory interface circuitry 234 over the C/A bus 236 to a local controller in the non-volatile memory 206. And the memory interface circuitry 234 may transmit to, or receive data from, the non-volatile memory 206 over the data bus 232. In some examples, the commands issued by the memory interface circuitry 234 may be supported by the non-volatile memory 206 but not the volatile memory 204 (e.g., the commands issued by the memory interface circuitry 234 may be different than the commands issued by the memory interface circuitry 240).

The memory interface circuitry 240 may communicate with the volatile memory 204 via one or more of the data bus interface 216 and the C/A bus interface 264. For example, the memory interface circuitry 240 may prompt the C/A bus interface 264 to relay commands issued by the memory interface circuitry 240 over the C/A bus 242 to a local controller of the volatile memory 204. And the memory interface circuitry 240 may transmit to, or receive data from, the volatile memory 204 over one or more data buses 238. In some examples, the commands issued by the memory interface circuitry 240 may be supported by the volatile memory 204 but not the non-volatile memory 206 (e.g., the commands issued by the memory interface circuitry 240 may be different than the commands issued by the memory interface circuitry 234).

Together, the components of the interface controller 202 may operate the non-volatile memory 206 as a main memory and the volatile memory 204 as a cache. Such operation may be prompted by one or more access commands (e.g., read/retrieval commands/requests and write/storage commands/requests) received from a host device.

In some examples, the interface controller 202 may receive a storage command from the host device. The storage command may be received over the C/A bus 226 and transferred to the command circuitry 230 via one or more of the C/A bus interface 210 and the decoder 228. The storage command may include or be accompanied by address bits that target a memory address of the non-volatile memory 206. The data to be stored may be received over the data bus 260 and transferred to the buffer 218 via the data bus interface 208. In a write-through mode, the interface controller 202 may transfer the data to both the non-volatile memory 206 and the volatile memory 204. In a write-back mode, the interface controller 202 may transfer the data to only the volatile memory 204. In either mode, the interface controller 202 may first check to see if the volatile memory 204 has memory cells available to store the data. To do so, the command circuitry 230 may reference the memory array 252 (e.g., using a set of the memory address bits) to determine whether one or more of the n sets (e.g., pages) of volatile memory cells associated with the memory address are empty (e.g., store random or invalid data). In some cases, a set of volatile memory cells in the volatile memory 204 may be referred to as a line or cache line.

If one of then associated sets of volatile memory cells is available for storing information, the interface controller 202 may transfer the data from the buffer 218 to the volatile memory 204 for storage in that set of volatile memory cells. But if no associated sets of volatile memory cells are empty, the interface controller 202 may initiate an eviction process to make room for the data in the volatile memory 204. The eviction process may involve transferring the old data (e.g., existing data) in one of the n associated sets of volatile memory cells to the buffer 220. The dirty information for the old data may also be transferred to the memory array 254 or register 258 for identification of dirty subsets of the old data. After the old data is stored in the buffer 220, the new data can be transferred from the buffer 218 to the volatile memory 204 and the old data can be transferred from the buffer 220 to the non-volatile memory 206. In some cases, dirty subsets of the old data are transferred to the non-volatile memory 206 and clean subsets (e.g., unmodified subsets) are discarded. The dirty subsets may be identified by the engine 246-b based on dirty information transferred (e.g., from the volatile memory 204) to the memory array 254 or register 258 during the eviction process.

In another example, the interface controller 202 may receive a retrieval command from the host device. The retrieval command may be received over the C/A bus 225 and transferred to the command circuitry 230 via one or more of the C/A bus interface 210 and the decoder 228. The retrieval command may include address bits that target a memory address of the non-volatile memory 206. Before attempting to access the targeted memory address of the non-volatile memory 206, the interface controller 202 may check to see if the volatile memory 204 stores the data. To do so, the command circuitry 230 may reference the memory array 252 (e.g., using a set of the memory address bits) to determine whether one or more of the n sets of volatile memory cells associated with the memory address stores the requested data. If the requested data is stored in the volatile memory 204, the interface controller 202 may transfer the requested data to the buffer 218 for transmission to the host device over the data bus 260.

If the requested data is not stored in the volatile memory 204, the interface controller 202 may retrieve the data from the non-volatile memory 206 and transfer the data to the buffer 218 for transmission to the host device over the data bus 260. Additionally, the interface controller 202 may transfer the requested data from the buffer 218 to the volatile memory 204 so that the data can be accessed with a lower latency during a subsequent retrieval operation. Before transferring the requested data, however, the interface controller 202 may first determine whether one or more of the n associated sets of volatile memory cells are available to store the requested data. The interface controller 202 may determine the availability of the n associated sets of volatile memory cells by communicating with the related cache management circuit set. If an associated set of volatile memory cells is available, the interface controller 202 may transfer the data in the buffer 218 to the volatile memory 204 without performing an eviction process. Otherwise, the interface controller 202 may transfer the data from the buffer 218 to the volatile memory 204 after performing an eviction process.

The memory subsystem 200 may be implemented in one or more configurations, including one-chip versions and multi-chip versions. A multi-chip version may include one or more constituents of the memory subsystem 200, including the interface controller 202, the volatile memory 204, and the non-volatile memory 206 (among other constituents or combinations of constituents), on a chip that is separate from a chip that includes one or more other constituents of the memory subsystem 200. For example, in one multi-chip version, respective separate chips may include each of the interface controller 202, the volatile memory 204, and the non-volatile memory 206. In contrast, a one-chip version may include the interface controller 202, the volatile memory 204, and the non-volatile memory 206 on a single chip.

The memory subsystem 200 may support dynamic page activation as described herein. In some examples, the interface controller 202 may receive read commands (e.g., from a host device) for data (e.g., pages of data). The commands may be received via, for example, C/A bus interface 210. For example, the interface controller 202 may receive a first read command via the C/A bus interface 210 for a first page of data stored at the non-volatile memory 206. The interface controller 202 may read the first page of data stored at the non-volatile memory 206 by communicating a command to the non-volatile memory 206 via C/A bus 236. The communicated command may be the first read command received from the host device, or may be a different command generated by the interface controller 202. The data may be read from the non-volatile memory 206 via the data bus 232 and may be communicated (e.g., to the host device) via the data bus interface 208.

In some examples, the interface controller 202 may include logic 262 for prefetching one or more additional pages of data based on the first read command. The logic 262 may, over time, track access operations performed on the non-volatile memory 206. The tracked access operations (e.g., the prior access history of the non-volatile memory 206) may indicate that one or more pages of data are often accessed together (e.g., accessed within a threshold duration of the other).

For example, when the interface controller 202 receives a first read command for a first page of data, the logic 262 may determine that the interface controller 202 is likely to receive a read command for a second page of data. The interface controller 202 may then read the first page of data and read (e.g., prefetch) the second page of data by transmitting one or more commands to the non-volatile memory 206 via the C/A bus 236. The first page of data may be read from the non-volatile memory 206 using the data bus 232 and may be communicated to the host device using the data bus interface 208. In some examples, the second page of data may also be communicated to the host device (e.g., using the data bus 232 and the data bus interface 208), or the second page of data may be stored in a buffer (e.g., buffer 218, buffer 220) until the interface controller 202 receives a second read command (e.g., a read command for the second page of data). Prefetching the second page of data before an associated read command may reduce the overall power consumption and latency of the memory subsystem 200 that would otherwise be incurred by performing separate read operations on the non-volatile memory 206 for both the first page and second page of data.

FIG. 3 illustrates an example of a memory subsystem 300 that supports dynamic page activation in accordance with examples in the present disclosure. Memory subsystem 300 may include an interface controller 305, which may include a request queue component 310, a logic component 312, and a scheduler component 325. In some examples, the logic component 312 may include an access history component 315 and a prefetch component 320. The interface controller 305 may communicate with a memory array 330 and may perform one or more operations related to dynamic page activation. The interface controller 305 may be configured to receive a read command (e.g., from a host device) that indicates an address (e.g., a page) of the memory array 330 to be read. In some examples, the interface controller 305 (and its associated components) may activate (e.g., prefetch) one or more pages of data in addition to the page associated with the read command. Prefetching data associated with a read command may reduce overall power consumption and latency of the memory subsystem 300.

The memory array 330 may include a plurality of memory cells. In some examples, the memory cells may be non-volatile (e.g., ferroelectric) memory cells. Each row of memory cells may be configured to store a quantity of data (e.g., 64 bytes) and may be referred to as a page (e.g., a page of data). The memory subsystem 300 may be configured to receive a command (e.g., a read command) for one or more pages of data. For example, the interface controller 305 may receive a read command and may activate and/or access a page of data associated with the command. In some examples, it may be desirable for the interface controller 305 to activate (e.g., prefetch) one or more pages of data in addition to the page(s) associated with a received read command. For example, the interface controller 305 may receive a read command for a first page of data (e.g., data located in a first memory page) and may prefetch a second page of data based on prior access operations performed on the memory array 330. By prefetching the second page of data, the interface controller 305 may reduce latency and power consumption that would otherwise be incurred due to the memory subsystem 300 receiving independent read commands and performing separate read operations (e.g., a first read command for the first page of data and a second read command for the second page of data).

The interface controller 305 may include various components that operate together and/or communicate with the memory array 330. For example, the interface controller 305 may include the request queue component 310, the logic component 312, and the scheduler component 325. The request queue component 310 may be configured to receive external commands associated with data stored at the memory array 330 (or another memory component of the memory subsystem 300). The logic component 312 may include an access history component 315 and/or a prefetch component 320 and may be configured to perform operations associated with access history of one or more memory pages. The scheduler component 325 may be configured to request one or more memory pages from the memory array 330. Each component associated with the interface controller 305 may be a single component or may consist of multiple sub-components that are configured to perform dynamic page activation as described herein.

In some examples, the request queue component 310 may be configured to receive one or more commands from an external device. For example, the request queue component 310 may receive a read command from a host device. The request queue component 310 may communicate with (e.g., be coupled with) the access history component 315 and/or the scheduler component 325. In some examples, when the request queue component 310 receives a command (e.g., a read command), the command may be provided (e.g., forwarded) to the scheduler component 325 to access the memory page associated with the command. Additionally or alternatively, an indication of the command (e.g., an address of the memory page associated with the command) may be provided to the access history component 315. As discussed herein, the access history component 315 may be configured to identify one or more additional pages of data based on prior access history of the memory array 330. Additional pages of data (e.g., pages of data in addition to the page associated with a read command) may be prefetched from the memory array 330, which may decrease latency and power consumption of the memory subsystem 300.

In some examples, the request queue component 310 may communicate an indication of a received command (e.g., a received read command) to the access history component 315. For example, the request queue component 310 may receive a read command that includes an address of a first memory page of the memory array 330. The request queue component 310 may communicate the address of the first memory page to the access history component 315, which may monitor access operations of the memory array 330 over time. In some examples, the access history component 315 may include logic that is configured to track each time a memory page is accessed (e.g., read from, written to, etc.).

Based on the tracked access operations, the access history component 315 may determine access patterns, such as certain pages of data that are commonly accessed together (e.g., read) within a period of time. For example, the tracked access patterns may indicate that a first page of data and a second page of data of the memory array 330 are commonly read within a threshold time. In some cases, it may be determined that a read command for the second page of data is received based on receiving a read command for the first page of data. In other examples, the tracked access patterns may indicate that a third page of data, a fourth page of data, and/or a fifth page of data, etc. of the memory array 330 may be commonly read together within the threshold time. Based on the access history component 315 identifying pages of data that are commonly accessed together, the additional page(s) of data (e.g., the pages other than the page identified by a read command) may be prefetched.

In some examples, the access history component 315 may be configured to indicate, track, and/or update a quantity of requests for a memory page (e.g., a first memory page) and one or more additional memory pages (e.g., a second memory page). The access history component 315 may include (or may be coupled with) an address history buffer (e.g., an open page tag register) that is configured to temporarily store access history based on read commands received for each address of the memory array 330. The address history buffer may store one or more bits that indicate that an access operation was performed on a particular page of data. The stored quantity of access operations (e.g., the stored bits) may be continually updated based on receiving access commands (e.g., a read command) for each page of the memory array 330. The bits may be stored, for example, while an associated address is open (e.g., during an access operation of the associated page of data). In some examples, the access history component 315 may identify relationships between associated pages of data based on the stored bits. In other examples, the stored data (e.g., the stored bits) may be processed by another component (e.g., the prefetch component 320) to determine whether to prefetch an additional page (or pages) of data based on the interface controller 305 receiving a read command.

In some examples, the prefetch component 320 may communicate with the access history component 315 regarding the prior access history of one or more memory pages (e.g., pages of data) of the memory array 330. The prefetch component 320 may be configured to receive data stored in the address history buffer and identify relationships between pages of the memory array 330 based on the data. The data may be used by the prefetch component 320 to determine that a first page of data and a second page of data of the memory array 330 are associated (e.g., commonly read within a threshold time). For example, the prefetch component 320 may determine that one or more read requests for one or more additional memory pages of the memory array 330 often follow an initial read request for a first memory page.

In other examples, the prefetch component 320 may determine additional information about data to be prefetched (e.g., address information about data to be prefetched) and/or generate additional commands (e.g., requests) for prefetching the data. The prefetch component 320 may generate a read request for one or more additional memory pages in the memory array 330 based on the prior access history. Additionally or alternatively, the prefetch component 320 may determine that certain pages of data are not related. For example, the prefetch component 320 may determine that a third page of the memory array 330 is not associated with a fourth page (e.g., upon receiving a read command for the third page). In such an example, only the third page of data may be read from the memory array 330.

In some cases, the prefetch component 320 may transmit an indication of the data (e.g., a command, a request) to be prefetched to the scheduler component 325. Additionally or alternatively, the prefetch component 320 may generate a command (e.g., a request) for prefetching one or more pages of data of the memory array 330. The indication of data or command may be transmitted to scheduler component 325, which may be configured to communicate with the memory array 330. The associated data may be read (e.g., prefetched) from the memory array 330 based on the communications between the scheduler component 325 and the memory array 330.

The scheduler component 325 may be configured to initiate a prefetch operation for data stored at the memory array 330 and/or transmit (e.g., relay) a read command received from a host device (e.g., received by the queue component 310). In one example, the scheduler component 325 may receive a read command (e.g., for a first page of data) from the queue component 310. In a parallel operation, the access history component 315 and/or prefetch component 320 may determine an additional page of data (e.g., a second page of data) to be prefetched. The prefetch component 320 may communicate an indication of the data to be prefetched to the scheduler component 325.

Upon receiving the indication of the data, the scheduler component 325 may generate a read command (e.g., a request) for both the first page of data (e.g., associated with the read command) and the second page of data (e.g., associated with the prefetch operation). The read command generated by the scheduler component 325 may be a new command (e.g., a command different than the read command for the first page of data) or may be a modified version of the read command for the first page of data. Modifying the read command for the first page of data may include modifying one or more bits of the read command such that the command is configured to read both the first page of data and the second page of data. The scheduler component 325 may transmit the generated command to the memory array 330 for reading the first page of data and prefetching the second page of data.

In another example, the scheduler component 325 may receive a read command (e.g., for a first page of data) from the queue component 310. In a parallel operation, the access history component 315 and/or prefetch component 320 may determine an additional page of data (e.g., a second page of data) to be prefetched. The prefetch component 320 may generate a command (e.g., a request) for the data to be prefetched to the scheduler component 325. Upon receiving the command from the prefetch component 320, the scheduler component 325 may transmit both the read command for the first page of data and the prefetch command for the second page of data to the memory array 330. The scheduler component 325 may transmit the commands in parallel (e.g., at a same time) or in series (e.g., one followed by another).

Upon reading and/or prefetching data from the memory array 330, the data associated with the initial read command (e.g., the first page of data) may be transmitted to the host device. In some examples, the prefetched data (e.g., the second page of data) may also be transmitted to the host device. However, in some examples, the prefetched data may be stored (e.g., temporarily stored) at a bank of volatile memory (e.g., a buffer) coupled with the interface controller 305. The bank of volatile memory may include a plurality of volatile memory cells (e.g., DRAM memory cells) and may be configured to store the prefetched data until an associated read command is received by the interface controller 305 (e.g., received by the queue component 310). Because the data was prefetched based on prior access history, the data may be stored at the buffer until an anticipated read command is received. Stated another way, the data may have been prefetched from the memory array 330 due to an increased probability that a read command for the data will be received within a threshold time. When the read command is received by the interface controller 305, one or more components (e.g., the scheduler component 325) may communicate with the buffer to transmit the prefetched data to the host. Transmitting the data from the buffer to the host device may reduce latency that would otherwise be incurred by reading the data directly from the memory array 330.

FIG. 4 illustrates an exemplary process flow diagram 400 for dynamic page activation in accordance with examples of the present disclosure. The process flow diagram 400 illustrates an example read operation and an example prefetching operation as discussed with reference to FIG. 3. The read and prefetch operation may be performed on a memory array 430 and/or memory bank 435, which may be coupled with an interface controller 405. The interface controller 405 may include a request queue component 410, an access history component 415, a prefetch component 420, and a scheduler component 425. In some examples, the memory array, interface controller, and associated components may be examples of the associated components described with reference to FIG. 3.

At 440, the request queue component 410 may receive a read command associated with a first memory page of the memory array 430. The read command may be received from an external device, such as a host device, SoC/processor, or the like. The request queue component 410 may be configured to communicate (e.g., transmit) the read command to the scheduler component 425 and/or communicate information associated with the read command (e.g., an address of the associated data) to the access history component 415.

At 445, the access history component 415 may determine prior access history associated with the first read command. For example, the access history component 445 may have monitored (e.g., continually monitored) access history associated with the first memory page. Based on the tracked access history, the access history component 415 may determine that the interface controller 405 is likely to receive a read command for a second page of data within a predefined duration. Based on the determination, the access history component 415 may transmit an indication to the scheduler component 425 to prefetch the second memory page. In other examples, the access history component 415 may communicate with the prefetch component 420 in order to identify and/or prefetch the second page of data.

At 450, the prefetch component 420 may optionally communicate with the access history component 415 regarding prefetching the second page of data. For example, the prefetch component 420 may identify an address of the second page of data based on the operations of the access history component 415. The address may be provided to the scheduler component 425 to prefetch the second page of data.

At 455, the scheduler component 425 may optionally modify the first read command so that the command is configured to access both the first page of data and the second page of data. In such an example, the scheduler component 425 may receive an address of the second page of data from the prefetch component 420. The scheduler component may use the address to modify one or more bits of the first read command for the first page of data. The read command generated by the scheduler component 425 may be transmitted to the memory array 430.

At 460, the first page of data may be read from the memory array 430 and the second page of data may be prefetched from the memory array 430. In some examples, the first page of data may be read based on the scheduler component 425 transmitting the first read command to the memory array 430. The second page of data may be prefetched from the memory array 430 based on the scheduler component 425 generating a command for the second page of data, or by modifying the first read command to also prefetch the second page of data. In some examples, at least the first page of data may be communicated to the external device (e.g., at 470). By providing the data directly from the memory array 430 to the external device, a separate read operation for the second page of data may not need to occur thus reducing the power consumption and latency of the memory device.

At 465, the prefetched second page of data may be optionally stored at a memory bank 435. As discussed herein, the memory bank may include a plurality of volatile memory cells. The second page of data may be stored at the memory bank 435 until the interface controller 405 receives a read command (e.g., a second read command) for the second page of data. When the second read command is received, the second page of data may be communicated to the external device directly from the memory bank 435 (e.g., at 470). By communicating the data directly from the memory bank 435, a separate read operation for the second page of data may not need to occur thus reducing the power consumption and latency of the memory device.

FIG. 5 shows a block diagram 500 of an interface controller 505 that supports dynamic page activation in accordance with examples as disclosed herein. The interface controller 505 may be an example of aspects of an interface controller as described with reference to FIGS. 1 through 4. The interface controller 505 may include a reception component 510, an identification component 515, a reading component 520, a storing component 525, a communication component 530, a determination component 535, a monitoring component 540, a modification component 545, and a generation component 550. Each of these modules may communicate, directly or indirectly, with one another (e.g., via one or more buses).

The reception component 510 may receive, at an interface controller, a read command for a first page of data stored at a memory array. In some examples, the reception component 510 may receive, at the interface controller, a second read command for the second page of data after reading the first page of data and the second page of data. In some examples, the reception component 510 may receive a third read command for a third page of data stored at the memory array.

The identification component 515 may identify a second page of data stored at the memory array based on receiving the read command and based on one or more prior access operations for the first page of data and the second page of data.

The reading component 520 may read the first page of data and the second page of data from the memory array based on identifying the second page of data stored at the memory array.

In some examples, the reading component 520 may read the third page of data from the memory array based on determining that the third page of data is not associated with another page of data.

The storing component 525 may store the second page of data at a bank of volatile memory based on reading the first page of data and the second page of data from the memory array.

The communication component 530 may communicate, from the bank of volatile memory, the second page of data based on receiving the second read command.

The determination component 535 may determine that, for the one or more prior access operations, a read command for the second page of data was received based on identifying the second page of data. In some examples, the determination component 535 may determine that a quantity of times a read command for the second page of data was received within a threshold duration of receiving the read command for the first page of data satisfies a threshold quantity. In some examples, the determination component 535 may determine that the third page of data is not associated with another page of data based on one or more prior access operations for the third page of data.

The monitoring component 540 may monitor a quantity of access operations performed on the first page of data and the second page of data, where determining that the quantity of times the read command for the second page of data satisfies the threshold quantity is based on monitoring the quantity of access operations.

The modification component 545 may modify the read command for the first page of data, where reading the first page of data and the second page of data from the memory array is based on modifying the read command.

The generation component 550 may generate a request for the second page of data based on identifying the second page of data stored at the memory array where reading the first page of data and the second page of data from the memory array is based on the read command and the request.

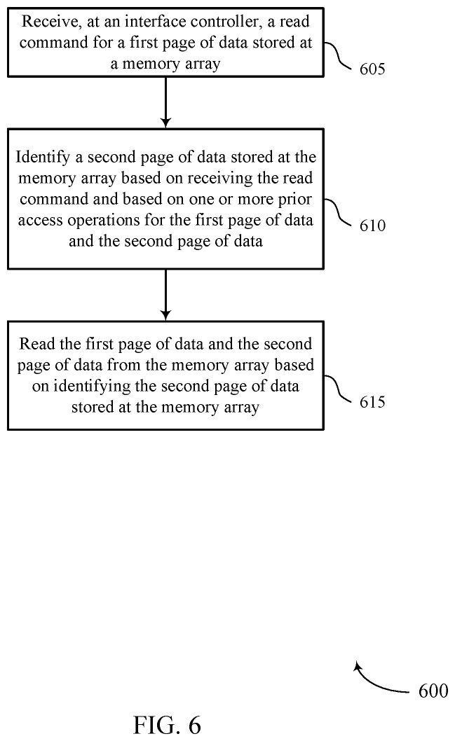

FIG. 6 shows a flowchart illustrating a method or methods 600 that supports dynamic page activation in accordance with aspects of the present disclosure. The operations of method 600 may be implemented by an interface controller or its components as described herein. For example, the operations of method 600 may be performed by an interface controller as described with reference to FIG. 5. In some examples, an interface controller may execute a set of instructions to control the functional elements of the interface controller to perform the described functions. Additionally or alternatively, an interface controller may perform aspects of the described functions using special-purpose hardware.

At 605, the interface controller may receive, at an interface controller, a read command for a first page of data stored at a memory array. The operations of 605 may be performed according to the methods described herein. In some examples, aspects of the operations of 605 may be performed by a reception component as described with reference to FIG. 5.

At 610, the interface controller may identify a second page of data stored at the memory array based on receiving the read command and based on one or more prior access operations for the first page of data and the second page of data. The operations of 610 may be performed according to the methods described herein. In some examples, aspects of the operations of 610 may be performed by an identification component as described with reference to FIG. 5.

At 615, the interface controller may read the first page of data and the second page of data from the memory array based on identifying the second page of data stored at the memory array. The operations of 615 may be performed according to the methods described herein. In some examples, aspects of the operations of 615 may be performed by a reading component as described with reference to FIG. 5.

In some examples, an apparatus as described herein may perform a method or methods, such as the method 600. The apparatus may include features, means, or instructions (e.g., a non-transitory computer-readable medium storing instructions executable by a processor) for receiving, at an interface controller, a read command for a first page of data stored at a memory array, identifying a second page of data stored at the memory array based on receiving the read command and based on one or more prior access operations for the first page of data and the second page of data, and reading the first page of data and the second page of data from the memory array based on identifying the second page of data stored at the memory array.

Some examples of the method 600 and the apparatus described herein may further include operations, features, means, or instructions for storing the second page of data at a bank of volatile memory based on reading the first page of data and the second page of data from the memory array.

Some examples of the method 600 and the apparatus described herein may further include operations, features, means, or instructions for receiving, at the interface controller, a second read command for the second page of data after reading the first page of data and the second page of data, and communicating, from the bank of volatile memory, the second page of data based on receiving the second read command.

Some examples of the method 600 and the apparatus described herein may further include operations, features, means, or instructions for determining that, for the one or more prior access operations, a read command for the second page of data was received based on identifying the second page of data.

In some examples of the method 600 and the apparatus described herein, determining that, for the one or more prior access operations, the read command for the second page of data was received based on receiving the read command for the first page of data may include operations, features, means, or instructions for determining that a quantity of times a read command for the second page of data was received within a threshold duration of receiving the read command for the first page of data satisfies a threshold quantity.

In some examples of the method 600 and the apparatus described herein, determining that, for the one or more prior access operations, the read command for the second page of data was received based on receiving the read command for the first page of data may include operations, features, means, or instructions for monitoring a quantity of access operations performed on the first page of data and the second page of data, where determining that the quantity of times the read command for the second page of data satisfies the threshold quantity may be based on monitoring the quantity of access operations.

Some examples of the method 600 and the apparatus described herein may further include operations, features, means, or instructions for modifying the read command for the first page of data, where reading the first page of data and the second page of data from the memory array may be based on modifying the read command.

Some examples of the method 600 and the apparatus described herein may further include operations, features, means, or instructions for generating a request for the second page of data based on identifying the second page of data stored at the memory array where reading the first page of data and the second page of data from the memory array may be based on the read command and the request.

Some examples of the method 600 and the apparatus described herein may further include operations, features, means, or instructions for receiving a third read command for a third page of data stored at the memory array, determining that the third page of data may be not associated with another page of data based on one or more prior access operations for the third page of data, and reading the third page of data from the memory array based on determining that the third page of data may be not associated with another page of data.

In some examples of the method 600 and the apparatus described herein, the memory array includes a non-volatile memory.

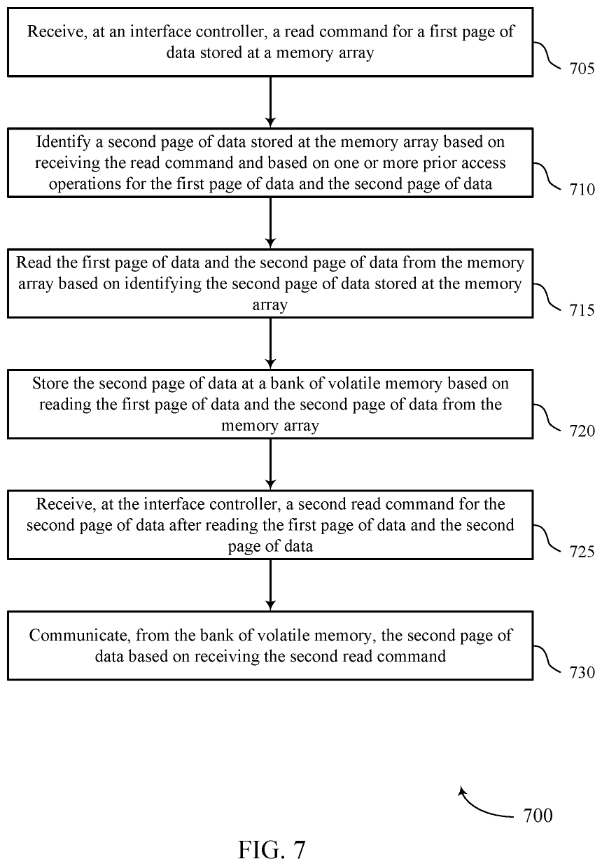

FIG. 7 shows a flowchart illustrating a method or methods 700 that supports dynamic page activation in accordance with aspects of the present disclosure. The operations of method 700 may be implemented by an interface controller or its components as described herein. For example, the operations of method 700 may be performed by an interface controller as described with reference to FIG. 5. In some examples, an interface controller may execute a set of instructions to control the functional elements of the interface controller to perform the described functions. Additionally or alternatively, an interface controller may perform aspects of the described functions using special-purpose hardware.

At 705, the interface controller may receive, at an interface controller, a read command for a first page of data stored at a memory array. The operations of 705 may be performed according to the methods described herein. In some examples, aspects of the operations of 705 may be performed by a reception component as described with reference to FIG. 5.

At 710, the interface controller may identify a second page of data stored at the memory array based on receiving the read command and based on one or more prior access operations for the first page of data and the second page of data. The operations of 710 may be performed according to the methods described herein. In some examples, aspects of the operations of 710 may be performed by an identification component as described with reference to FIG. 5.

At 715, the interface controller may read the first page of data and the second page of data from the memory array based on identifying the second page of data stored at the memory array. The operations of 715 may be performed according to the methods described herein. In some examples, aspects of the operations of 715 may be performed by a reading component as described with reference to FIG. 5.

At 720, the interface controller may store the second page of data at a bank of volatile memory based on reading the first page of data and the second page of data from the memory array. The operations of 720 may be performed according to the methods described herein. In some examples, aspects of the operations of 720 may be performed by a storing component as described with reference to FIG. 5.

At 725, the interface controller may receive, at the interface controller, a second read command for the second page of data after reading the first page of data and the second page of data. The operations of 725 may be performed according to the methods described herein. In some examples, aspects of the operations of 725 may be performed by a reception component as described with reference to FIG. 5.

At 730, the interface controller may communicate, from the bank of volatile memory, the second page of data based on receiving the second read command. The operations of 730 may be performed according to the methods described herein. In some examples, aspects of the operations of 730 may be performed by a communication component as described with reference to FIG. 5.

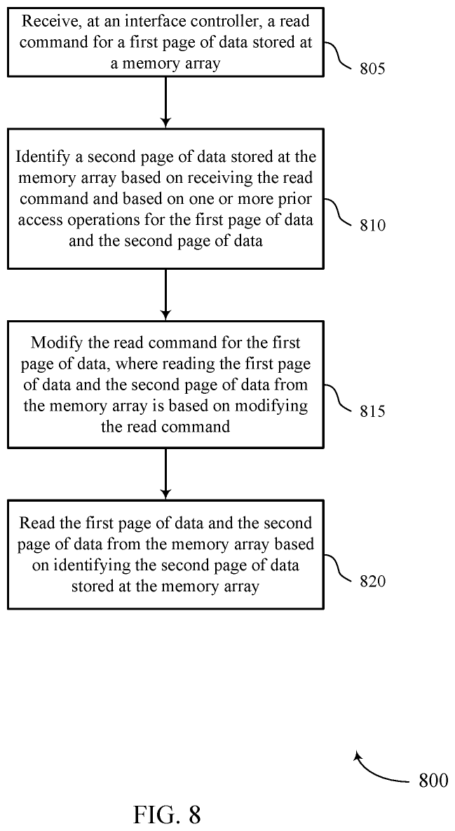

FIG. 8 shows a flowchart illustrating a method or methods 800 that supports dynamic page activation in accordance with aspects of the present disclosure. The operations of method 800 may be implemented by an interface controller or its components as described herein. For example, the operations of method 800 may be performed by an interface controller as described with reference to FIG. 5. In some examples, an interface controller may execute a set of instructions to control the functional elements of the interface controller to perform the described functions. Additionally or alternatively, an interface controller may perform aspects of the described functions using special-purpose hardware.

At 805, the interface controller may receive, at an interface controller, a read command for a first page of data stored at a memory array. The operations of 805 may be performed according to the methods described herein. In some examples, aspects of the operations of 805 may be performed by a reception component as described with reference to FIG. 5.

At 810, the interface controller may identify a second page of data stored at the memory array based on receiving the read command and based on one or more prior access operations for the first page of data and the second page of data. The operations of 810 may be performed according to the methods described herein. In some examples, aspects of the operations of 810 may be performed by an identification component as described with reference to FIG. 5.

At 815, the interface controller may modify the read command for the first page of data, where reading the first page of data and the second page of data from the memory array is based on modifying the read command. The operations of 815 may be performed according to the methods described herein. In some examples, aspects of the operations of 815 may be performed by a modification component as described with reference to FIG. 5.

At 820, the interface controller may read the first page of data and the second page of data from the memory array based on identifying the second page of data stored at the memory array. The operations of 820 may be performed according to the methods described herein. In some examples, aspects of the operations of 820 may be performed by a reading component as described with reference to FIG. 5.

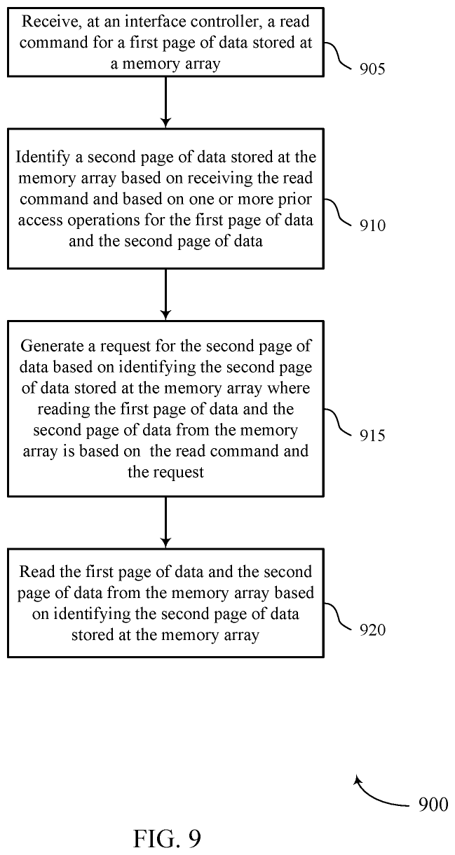

FIG. 9 shows a flowchart illustrating a method or methods 900 that supports dynamic page activation in accordance with aspects of the present disclosure. The operations of method 900 may be implemented by an interface controller or its components as described herein. For example, the operations of method 900 may be performed by an interface controller as described with reference to FIG. 5. In some examples, an interface controller may execute a set of instructions to control the functional elements of the interface controller to perform the described functions. Additionally or alternatively, an interface controller may perform aspects of the described functions using special-purpose hardware.

At 905, the interface controller may receive, at an interface controller, a read command for a first page of data stored at a memory array. The operations of 905 may be performed according to the methods described herein. In some examples, aspects of the operations of 905 may be performed by a reception component as described with reference to FIG. 5.

At 910, the interface controller may identify a second page of data stored at the memory array based on receiving the read command and based on one or more prior access operations for the first page of data and the second page of data. The operations of 910 may be performed according to the methods described herein. In some examples, aspects of the operations of 910 may be performed by an identification component as described with reference to FIG. 5.

At 915, the interface controller may generate a request for the second page of data based on identifying the second page of data stored at the memory array where reading the first page of data and the second page of data from the memory array is based on the read command and the request. The operations of 915 may be performed according to the methods described herein. In some examples, aspects of the operations of 915 may be performed by a generation component as described with reference to FIG. 5.

At 920, the interface controller may read the first page of data and the second page of data from the memory array based on identifying the second page of data stored at the memory array. The operations of 920 may be performed according to the methods described herein. In some examples, aspects of the operations of 920 may be performed by a reading component as described with reference to FIG. 5.

It should be noted that the methods described above describe possible implementations, and that the operations and the steps may be rearranged or otherwise modified and that other implementations are possible. Furthermore, portions from two or more of the methods may be combined.

An apparatus is described. The apparatus may include a memory array configured to store data in a set of memory pages, a queue component configured to receive a read command for a first page of data stored at the memory array, a logic component coupled with the queue component and configured to identify a second page of data stored at the memory array based on the read command and based on one or more prior access operations for the first page of data and the second page of data, and a scheduler component coupled with the logic component and the memory array, the scheduler component configured to receive the read command and an indication of the second page of data and to initiate reading the first page of data and the second page of data.

Some examples of the apparatus may include a bank of volatile memory coupled with the memory array and configured to store at least the second page of data based on reading the first page of data and the second page of data.

In some examples, the queue component may be configured to receive a second read command for the second page of data stored at the bank of volatile memory, and where the second page of data may be communicated from the bank of volatile memory based on the queue component receiving the second read command.

In some examples, the logic component may include operations, features, means, or instructions for an access history component coupled with the queue component and configured to monitor a quantity of access operations performed on the first page of data, the second page of data, or both.

In some examples, the logic component may include operations, features, means, or instructions for a prefetch component coupled with the access history component and configured to identify the second page of data based on a quantity of read commands for the second page of data being received after a quantity of read commands for the first page of data satisfying a threshold quantity.

In some examples, the scheduler component may be configured to modify the read command and issue the modified read command to the memory array for the first page of data and the second page of data.

In some examples, the scheduler component configured to receive the read command from the queue component and the indication of the second page of data from the logic component.

An apparatus is described. The apparatus may include a memory array configured to store a set of memory pages and an interface controller coupled with the memory array and operable to receive a read command for a first page of data stored at the memory array, identify a second page of data stored at the memory array based on receiving the read command and based on one or more prior access operations for the first page of data and the second page of data, and initiate reading the first page of data and the second page of data from the memory array based on identifying the second page of data stored at the memory array.

Some examples may further include storing the second page of data at a bank of volatile memory based on initiating read the first page of data and the second page of data.

Some examples may further include receiving a second read command for the second page of data after storing the second page of data at the bank of volatile memory, and transmit the second page of data from the bank of volatile memory based on receiving the second read command.

Some examples may further include identifying a relationship between access operations on the first page of data and the second page of data, where identifying the second page of data may be based on the relationship between the access operations on the first page of data and the second page of data.

Some examples may further include storing an indication of a quantity of access operations performed on the first page of data and the second page of data, and determine that the quantity of times a read command for the second page of data may be received, where the relationship between the access operations may be based on the quantity of times a read command for the second page of data may be received satisfying a threshold value.

Some examples may further include updating the indication of the quantity of access operations performed on the first page of data and the second page of data based on receiving subsequent access commands for the first page of data and the second page of data.

Some examples may further include receiving a command for an additional page of data stored at the memory array, determine that the additional page of data may be not associated with any pages of data based on one or more prior access operations, and reading the additional page of data from the memory array based on determining that the additional page of data may be not associated with any pages of data.

Some examples may further include modifying the received read command for the first page of data, where the first page of data and the second page of data may be read from the memory array based on the modified read command.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, it will be understood by a person of ordinary skill in the art that the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to condition of moving from an open-circuit relationship between components in which signals are not presently capable of being communicated between the components over a conductive path to a closed-circuit relationship between components in which signals are capable of being communicated between components over the conductive path. When a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other when the switch is open. When a controller isolates two components, the controller affects a change that prevents signals from flowing between the components using a conductive path that previously permitted signals to flow.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as a n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” when a voltage greater than or equal to the transistor's threshold voltage is applied to the transistor gate. The transistor may be “off” or “deactivated” when a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A non-transitory computer-readable medium storing code at an electronic device, the code comprising instructions executable by a processor to:
receive, at an interface controller, a read command for a first page of data stored at a memory array;
identify a second page of data stored at the memory array based at least in part on receiving the read command and based at least in part on one or more prior access operations for the first page of data and the second page of data; and
read the first page of data and the second page of data from the memory array based at least in part on identifying the second page of data stored at the memory array.

2. The non-transitory computer-readable medium of claim 1, wherein the instructions are further executable to:
store the second page of data at a bank of volatile memory based at least in part on reading the first page of data and the second page of data from the memory array.

3. The non-transitory computer-readable medium of claim 2, wherein the instructions are further executable to:
receive, at the interface controller, a second read command for the second page of data after reading the first page of data and the second page of data; and
communicate, from the bank of volatile memory, the second page of data based at least in part on receiving the second read command.

4. The non-transitory computer-readable medium of claim 1, wherein the instructions are further executable to:
determine that, for the one or more prior access operations, a read command for the second page of data was received based at least in part on identifying the second page of data.

5. The non-transitory computer-readable medium of claim 4, wherein determining that, for the one or more prior access operations, the read command for the second page of data was received based at least in part on receiving the read command for the first page of data comprises:
determining that a quantity of times a read command for the second page of data was received within a threshold duration of receiving the read command for the first page of data satisfies a threshold quantity.

6. The non-transitory computer-readable medium of claim 5, wherein determining that, for the one or more prior access operations, the read command for the second page of data was received based at least in part on receiving the read command for the first page of data comprises:
monitoring a quantity of access operations performed on the first page of data and the second page of data, wherein determining that the quantity of times the read command for the second page of data satisfies the threshold quantity is based at least in part on monitoring the quantity of access operations.

7. The non-transitory computer-readable medium of claim 1, wherein the instructions are further executable to:
modify the read command for the first page of data, wherein reading the first page of data and the second page of data from the memory array is based at least in part on modifying the read command.

8. The non-transitory computer-readable medium of claim 1, wherein the instructions are further executable to:
generate a request for the second page of data based at least in part on identifying the second page of data stored at the memory array wherein reading the first page of data and the second page of data from the memory array is based at least in part on the read command and the request.

9. The non-transitory computer-readable medium of claim 1, wherein the instructions are further executable to:
receive a third read command for a third page of data stored at the memory array;
determine that the third page of data is not associated with another page of data based on one or more prior access operations for the third page of data; and
read the third page of data from the memory array based at least in part on determining that the third page of data is not associated with the another page of data.

10. The non-transitory computer-readable medium of claim 1, wherein the memory array comprises a non-volatile memory.

11. An apparatus, comprising:
a memory array configured to store data in a plurality of memory pages;
a queue component configured to receive a read command for a first page of data stored at the memory array;
a logic component coupled with the queue component and configured to identify a second page of data stored at the memory array based at least in part on the read command and based at least in part on one or more prior access operations for the first page of data and the second page of data; and
a scheduler component coupled with the logic component and the memory array, the scheduler component configured to receive the read command and an indication of the second page of data and to initiate reading the first page of data and the second page of data.

12. The apparatus of claim 11, further comprising:
a bank of volatile memory coupled with the memory array and configured to store at least the second page of data based at least in part on reading the first page of data and the second page of data.

13. The apparatus of claim 12, wherein the queue component is configured to receive a second read command for the second page of data stored at the bank of volatile memory, and wherein the second page of data is communicated from the bank of volatile memory based at least in part on the queue component receiving the second read command.

14. The apparatus of claim 11, wherein the logic component comprises an access history component coupled with the queue component and configured to monitor a quantity of access operations performed on the first page of data, the second page of data, or both.

15. The apparatus of claim 14, wherein the logic component comprises a prefetch component coupled with the access history component and configured to identify the second page of data based at least in part on a quantity of read commands for the second page of data being received after a quantity of read commands for the first page of data satisfying a threshold quantity.

16. The apparatus of claim 11, wherein the scheduler component is configured to modify the read command and issue the modified read command to the memory array for the first page of data and the second page of data.

17. The apparatus of claim 11, wherein the scheduler component configured to receive the read command from the queue component and the indication of the second page of data from the logic component.

18. An apparatus, comprising:
a memory array configured to store a plurality of memory pages; and
an interface controller coupled with the memory array and operable to:
receive a read command for a first page of data stored at the memory array;
identify a second page of data stored at the memory array based at least in part on receiving the read command and based at least in part on one or more prior access operations for the first page of data and the second page of data; and
initiate reading the first page of data and the second page of data from the memory array based at least in part on identifying the second page of data stored at the memory array.

19. The apparatus of claim 18, wherein the interface controller is operable to:
store the second page of data at a bank of volatile memory based at least in part on initiating read the first page of data and the second page of data.

20. The apparatus of claim 19, wherein the interface controller is operable to:
receive a second read command for the second page of data after storing the second page of data at the bank of volatile memory; and
transmit the second page of data from the bank of volatile memory based at least in part on receiving the second read command.

21. The apparatus of claim 18, wherein the interface controller is operable to:
identify a relationship between access operations on the first page of data and the second page of data, wherein identifying the second page of data is based at least in part on the relationship between the access operations on the first page of data and the second page of data.

22. The apparatus of claim 21, wherein the interface controller is operable to:
store an indication of a quantity of access operations performed on the first page of data and the second page of data; and
determine that a quantity of times a read command for the second page of data is received, wherein the relationship between the access operations is based at least in part on the quantity of times the read command for the second page of data is received satisfying a threshold value.

23. The apparatus of claim 22, wherein the interface controller is operable to:
update the indication of the quantity of access operations performed on the first page of data and the second page of data based at least in part on receiving subsequent access commands for the first page of data and the second page of data.

24. The apparatus of claim 18, wherein the interface controller is operable to:
receive a command for an additional page of data stored at the memory array;
determine that the additional page of data is not associated with any pages of data based on one or more prior access operations; and
reading the additional page of data from the memory array based at least in part on determining that the additional page of data is not associated with any pages of data.

25. The apparatus of claim 18, wherein the interface controller is operable to:
modify the received read command for the first page of data, wherein the first page of data and the second page of data are read from the memory array based at least in part on the modified read command.
